(19) United States
(12) Patent Application Publication
(10) Pub. No.: US 2019/0341788 A1
(43) Pub. Date: Nov. 7, 2019

(54) ENERGY STORAGE SYSTEM FOR VEHICLE

(71) Applicants: Hyundai Motor Company, Seoul (KR); Kia Motors Corporation, Seoul (KR)

(72) Inventors: Yong Jin Lee, Hwaseong (KR); Tae Hyuck Kim, Cheonan (KR); Yong Hwan Choi, Yongin (KR); Hae Kyu Lim, Bucheon (KR)

(21) Appl. No.: 16/172,811

(22) Filed: Oct. 28, 2018

(30) Foreign Application Priority Data
May 2, 2018 (KR) 10-2018-0050518

(51) Int. Cl. H02J 7/00; H02H 7/18; H01M 10/48; B60L 3/00; H01M 2/34; H01M 10/42; B60L 11/18; H01M 2/10

(52) U.S. Cl. CPC H02J 7/0026; H02H 7/18; H01M 10/482; B60L 3/0046; H01M 2/345; H01M 2010/4271; B60L 11/1864; H01M 2/1016; H02J 2007/0037; H01M 2220/20; H01M 10/425

(57) ABSTRACT

An energy storage system for a vehicle is provided. The system includes a plurality of energy storage cells that are mounted within an energy storage cell mounting part and stacked to be in surface-contact with each other. A first plate has a first surface coupled to be in surface-contact with an exposed surface of an energy storage cell positioned at an outermost side among the plurality of energy storage cells. An elastic member has a first side coupled to a second surface of the first plate and a second side fixedly coupled to the energy storage cell mounting part. The elastic member provides repulsive force of a certain magnitude or greater in a direction of the stacked energy storage cells through the first plate.

### CROSS REFERENCE TO RELATED APPLICATION

The present application claims priority to Korean Patent Application No. 10-2018-0050518, filed May 2, 2018, the entire contents of which is incorporated herein for all purposes by this reference.

### BACKGROUND

### Technical Field

The present disclosure relates to an energy storage system for a vehicle, and more particularly, to an energy storage system that allows a surface pressure of a certain magnitude or greater to be applied to energy storage cells and shuts off power supplied to the energy storage cells when the energy storage cells are overcharged.

### Description of the Related Art

In general, hybrid electric vehicles, electric vehicles, and fuel cell vehicles use a high-voltage battery capable of supplying electric energy for driving the vehicles. Such a high-voltage battery is configured in a battery pack that may generate a high voltage by connecting a plurality of unit cells or modules, and generates high power using the battery pack.

Meanwhile, an electrolyte is injected into the cell of the high-voltage battery, and when the battery is overcharged, a voltage increases and the electrolyte in the cell is decomposed due to overheating causing inflammable gas to be generated inside the cell of the battery. As a result, a swelling phenomenon in which the cell of the battery expands occurs and thus, the risk of ignition and explosion of the battery increases. Accordingly, a technology has been actively developed for forcibly shutting off the power of the battery when the swelling phenomenon occurs due to the overcharging of the battery.

However, the related art uses a structure in which a surface pressure is not applied to a portion in which the cell of the battery is expanded to shut off the power of the battery, when the swelling phenomenon occurs due to the overcharging of the battery. As a result, durability of the cell of the battery is decreased. Accordingly, a technology capable of shutting off power supplied to the battery when the battery is overcharged while satisfying durability of the cell of the battery is required.

The contents described as the related art have been provided merely to assist in understanding the background of the present disclosure and should not be considered as corresponding to the related art known to those having ordinary skill in the art.

### SUMMARY

An object of the present disclosure is to provide an energy storage system for a vehicle capable of improving durability of energy storage cells by providing repulsive force of a certain magnitude or greater in a direction of a plurality of stacked energy storage cells through a first plate by an elastic member to provide surface pressure of a certain magnitude or greater to the plurality of energy storage cells which are stacked to be in surface-contact with each other, and improving stability by shutting off power supplied to the energy storage cells when the energy storage cells are overcharged.

According to an exemplary embodiment of the present disclosure, an energy storage system for a vehicle may include: a plurality of energy storage cells mounted in an energy storage cell mounting part and stacked to be in surface-contact with each other; a first plate having a first surface coupled to be in surface-contact with an exposed surface of an energy storage cell positioned at the outermost side among the plurality of energy storage cells; and an elastic member having a first side coupled to a second surface of the first plate and a second side fixedly coupled to the energy storage cell mounting part, and providing repulsive force of a certain magnitude or greater in a direction of the stacked energy storage cells through the first plate.

The energy storage system for a vehicle may further include a switching part coupled to the energy storage cell mounting part and configured to shut off power supplied to the plurality of energy storage cells. When the energy storage cells are charged at a preset value or less, the switching part may be coupled to a position which is not in contact with the first plate, when the elastic member is compressed as the energy storage cells are expanded. When the energy storage cells are charged above a preset value, the switching part may be coupled to a position which is in contact with the first plate, when the elastic member is compressed as the energy storage cells are expanded. When the first plate is in contact with the switching part, the power supplied to the plurality of energy storage cells may be shut off.

Additionally, a protrusion may be formed on the second surface of the first plate. When the energy storage cells are charged at the preset value or less, the switching part may be coupled to a position which is not in contact with the protrusion of the first plate, when the elastic member is compressed as the energy storage cells are expanded. When the energy storage cells are charged above the preset value, the switching part may be coupled to a position which is in contact with the protrusion of the first plate, when the elastic member is compressed as the energy storage cells are expanded. When the protrusion of the first plate is in contact with the switching part, the power supplied to the plurality of energy storage cells may be shut off.

The energy storage system for a vehicle may further include a second plate positioned at a distance spaced apart from the first plate by a predetermined interval, and coupled to be fixed to the energy storage cell mounting part. The elastic member may be positioned between the first plate and the second plate, have a first side coupled to the other surface of the first plate and a second side coupled to a first surface of the second plate, and provide the repulsive force of the certain magnitude or greater in the direction of the stacked energy storage cells through the first plate.

The switching part may be coupled to the second plate. When the energy storage cells are charged at a preset value or less, the switching part may be coupled to a position which is not in contact with the first plate, when the elastic member is compressed as the energy storage cells are expanded. When the energy storage cells are charged above a preset value, the switching part may be coupled to a position which is in contact with the first plate, when the elastic member is compressed as the energy storage cells are expanded. When the first plate is in contact with the switching part, the power supplied to the plurality of energy storage cells may be shut off. The elastic member may be a plate spring or a coil spring.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a perspective view illustrating an energy storage system for a vehicle according to an exemplary embodiment of the present disclosure;

FIG. 2 is a view illustrating a shape before a first plate is coupled to an energy storage cell, in the energy storage system for a vehicle according to an exemplary embodiment of the present disclosure;

FIG. 3 is a view illustrating a shape in which initial surface pressure is applied to the energy storage cell, in the energy storage system for a vehicle according to an exemplary embodiment of the present disclosure;

FIG. 4 is a view illustrating a shape in which the energy storage cell is expanded and an elastic member is compressed while the energy storage cell is charged and discharged, in the energy storage system for a vehicle according to an exemplary embodiment of the present disclosure;

FIG. 5 is a view illustrating a shape in which the elastic member is compressed and a first plate is in contact with a switching part when the energy storage cell is charged above a predetermined value, in the energy storage system for a vehicle according to an exemplary embodiment of the present disclosure; and

FIG. 6 is a perspective view illustrating an energy storage system for a vehicle according to another exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

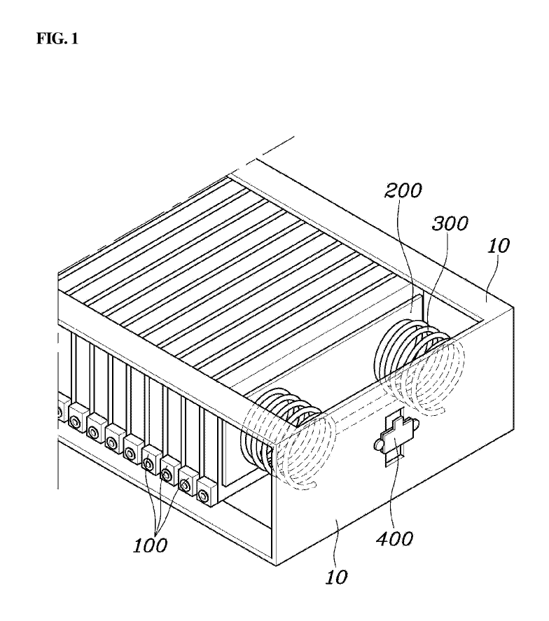

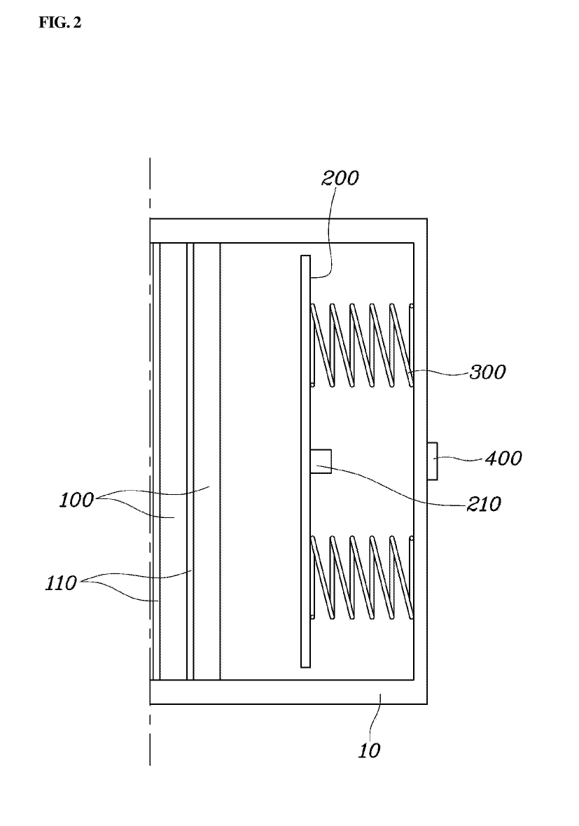

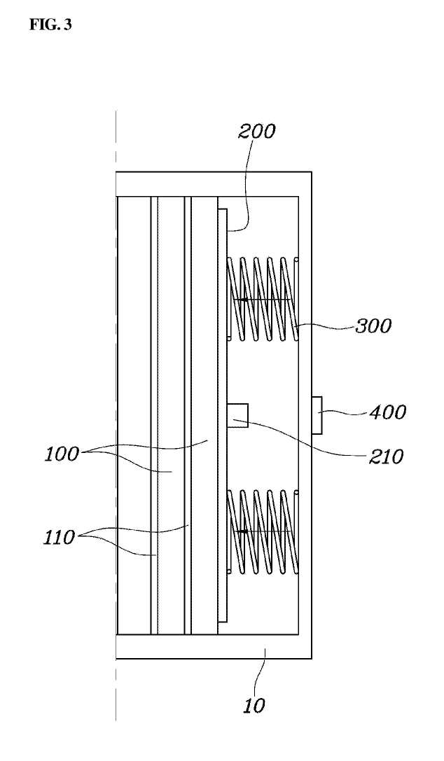

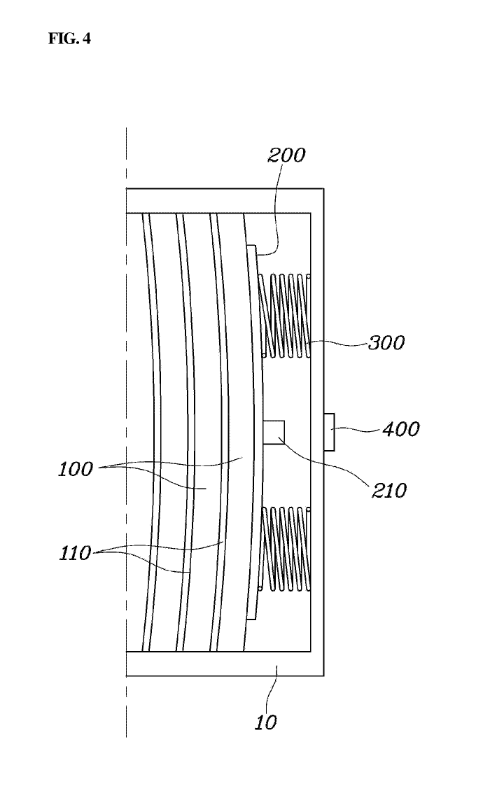

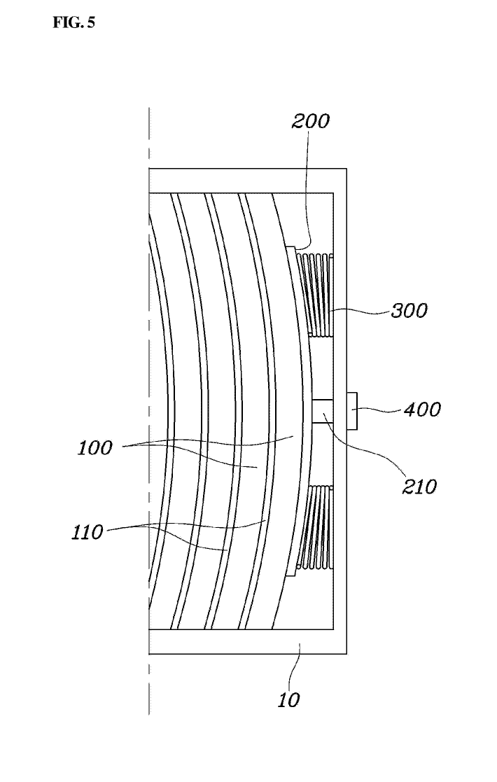

Hereinafter, an energy storage system for a vehicle according to an exemplary embodiment of the present disclosure will be described with reference to the accompanying drawings. FIG. 1 is a perspective view illustrating an energy storage system for a vehicle according to an exemplary embodiment of the present disclosure, FIG. 2 is a view illustrating a shape before a first plate is coupled to an energy storage cell, FIG. 3 is a view illustrating a shape in which initial surface pressure is applied to the energy storage cell, FIG. 4 is a view illustrating a shape in which the energy storage cell is expanded and an elastic member is compressed while the energy storage cell is charged and discharged, and FIG. 5 is a view illustrating a shape in which the elastic member is compressed and a first plate is in contact with a switching part when the energy storage cell is charged above a predetermined value.

As illustrated in FIG. 1, an energy storage system for a vehicle according to an exemplary embodiment of the present disclosure may include a plurality of energy storage cells 100 mounted within an energy storage cell mounting part 10, a first plate 200 having a first surface coupled to be in surface-contact with an exposed surface of an energy storage cell positioned at the outermost side among the plurality of energy storage cells, and an elastic member 300 configured to provide repulsive force of a certain magnitude or greater in a direction of stacked energy storage cells through the first plate 200. Hereinafter, a detailed configuration of the energy storage system for a vehicle according to the present disclosure will be described in more detail. As illustrated in FIG. 1, the energy storage cells 100 may be mounted within an energy storage cell mounting part 10. In particular, a structure of the energy storage cell mounting part 10 illustrated in FIG. 1 is merely an example, and is not limited thereto. For example, various structures may be used as the energy storage cell mounting part according to the present disclosure, including a structure in which all surfaces are closed, as long as the energy storage cells 100 may be mounted therein. Further, various materials capable of securing rigidity, stability, and durability, including a metal or the like may be used as a material of the energy storage cell mounting part.

The plurality of energy storage cells 100 may be stacked to be in surface-contact with each other, and the respective energy storage cells 100 may be electrically connected to each other. In particular, the plurality of energy storage cells 100 are stacked to be in surface-contact with each other to provide a surface pressure to each of the energy storage cells 100 when the elastic member 300 to be described below provides repulsive force in a direction of the plurality of energy storage cells 100 through the first plate 200. A plate 110 or the like having a shape that corresponds to a surface of the energy storage cell may be inserted between the energy storage cells 100.

Furthermore, the energy storage cells 100 may be configured to store electric energy and provide electric energy for driving a motor or the like of a vehicle. According to an exemplary embodiment, the energy storage cells 100 may be high-voltage battery cells configured to store and provide electric energy for driving the motor of the vehicle. However, this is merely one example, and various apparatuses may be used as the energy storage cells according to the present disclosure including a super-capacitor or the like, capable of storing and providing electric energy for driving the motor or the like of the vehicle.

As illustrated in FIGS. 1 to 3, the first plate 200 may have a first surface coupled to be in surface-contact with an exposed surface of the energy storage cell 100 positioned at the outermost side among the plurality of energy storage cells. The first surface of the first plate 200 may be coupled to be in surface-contact with the exposed surface of the energy storage cell 100 positioned at the outermost side to thus provide a surface pressure to the plurality of stacked energy storage cells 100, when repulsive force is provided in a direction in which the energy storage cells 100 are stacked from the elastic member 300 coupled to a second surface of the first plate 200. To improve a lifespan of the energy storage cells 100, a surface pressure of a certain magnitude or greater needs to be provided to each of the energy storage cells 100.

According to the present disclosure, the plurality of energy storage cells 100 may be stacked to be in surface-contact with each other and the first plate 200 may be coupled to be in surface-contact with the exposed surface of the energy storage cell 100 positioned at the outermost side, and thus, the surface pressure may be applied to the plurality of energy storage cells 100. Accordingly, an endurance life of the energy storage cells 100 may be improved.

Moreover, a protrusion 210 may be formed on the second surface of the first plate 200. When the energy storage cells 100 are charged above a predetermined value, the protrusion 210 may be in contact with the switching part 400 to shut off power supplied to the plurality of energy storage cells 100, when the elastic member 300 is compressed as the energy storage cells 100 are expanded.

The elastic member 300 may have a first side coupled to the second surface of the first plate 200 and a second side fixedly coupled to the energy storage cell mounting part 10, and may be configured to provide the repulsive force of a certain magnitude or greater in the direction of the stacked energy storage cells 100 through the first plate 200. Particularly, the elastic member 300 may be a plate spring or a coil spring according to an exemplary embodiment. However, the elastic member is not limited thereto, and various elastic bodies may be used as the elastic member according to the present disclosure that provide the repulsive force of the predetermined magnitude or greater in the direction the stacked energy storage cells 100 through the first plate 200.

Further, the elastic member 300 as illustrated in FIG. 2 may be compressed by a predetermined amount as illustrated in FIG. 3 while the first plate 200 is coupled to the exposed surface of the energy storage cell 100 positioned at the outermost side. In particular, the elastic member 300 may provide the repulsive force in the direction of the stacked energy storage cells through the first plate 200 with elastic force generated when being compressed by the predetermined amount. In other words, according to the present disclosure, the repulsive force of the certain magnitude or greater may be provided to the first plate 200 as illustrated in FIG. 3 as the elastic member 300 is compressed by the predetermined amount from an instant at which the energy storage cells 100, the first plate 200, and the elastic member 300 are coupled to each other. Accordingly, a surface pressure of a certain magnitude or greater may be provided to the plurality of energy storage cells 100.

As described above, according to the present disclosure, durability of the energy storage cells may be improved by providing the repulsive force of the certain magnitude or greater in the direction of the plurality of stacked energy storage cells through the first plate by the elastic member to thus provide the surface pressure of the certain magnitude or greater to the plurality of energy storage cells which are stacked to be in surface-contact with each other.

The energy storage system for a vehicle according to the present disclosure may further include a switching part 400 coupled to the energy storage cell mounting part 10 and configured to shut off the power supplied to the plurality of energy storage cells 100. In particular, the switching part 400 may be electrically connected to a circuit configured to supply the power to the plurality of energy storage cells 100, and may be configured to shut off the power supplied to the energy storage cells 100 when the switching part 400 is pushed.

In particular, when the energy storage cells 100 are charged at a preset value or less, the switching part 400 may be coupled to a position which is not in contact with the first plate 200, when the elastic member 300 is compressed as the energy storage cells 100 are expanded. According to an exemplary embodiment, when the protrusion 210 is formed on the second surface of the first plate 200, when the energy storage cells 100 are charged at a preset value or less, the switching part 400 may be coupled to a position which is not in contact with the protrusion 210 of the first plate 200, when the elastic member 300 is compressed as the energy storage cells 100 are expanded.

Further, when the energy storage cells 100 are charged above the preset value, the switching part 400 may be coupled to a position which is in contact with the first plate 200, when the elastic member 300 is compressed as the energy storage cells 100 are expanded. According to an exemplary embodiment, when the protrusion 210 is formed on the second surface of the first plate 200, when the energy storage cells 100 are charged above the preset value, the switching part 400 may be coupled to a position which is in contact with the protrusion 210 of the first plate 200, when the elastic member 300 is compressed as the energy storage cells 100 are expanded. When the first plate 200 or the protrusion 210 is in contact with the switching part 400, the switching part 400 may be configured to shut off the power supplied to the plurality of energy storage cells 100. Notably, the switching part 400 may be operated by a controller having a processor and a memory.

As described above, according to the present disclosure, the switching part 400 may be coupled to the position which is not in contact with the first plate 200 when the energy storage cells are charged at the preset value or less when the elastic member 300 is compressed as the energy storage cells 100 are expanded, and may be in contact with the first plate 200 when the energy storage cells 100 are charged above the preset value when the elastic member 300 is compressed as the energy storage cells 100 are expanded, thereby making it possible to further improve stability by shutting off the power supplied to the energy storage cells 100 during the overcharging in which the energy storage cells are charged above the preset value.

Moreover, although the drawings of the present disclosure illustrate that each of the energy storage cells 100 is expanded constantly when the energy storage cells 100 are expanded while being charged, each of the energy storage cells 100 may be expanded irregularly when the energy storage cells 100 are expanded while being overcharged according to an exemplary embodiment

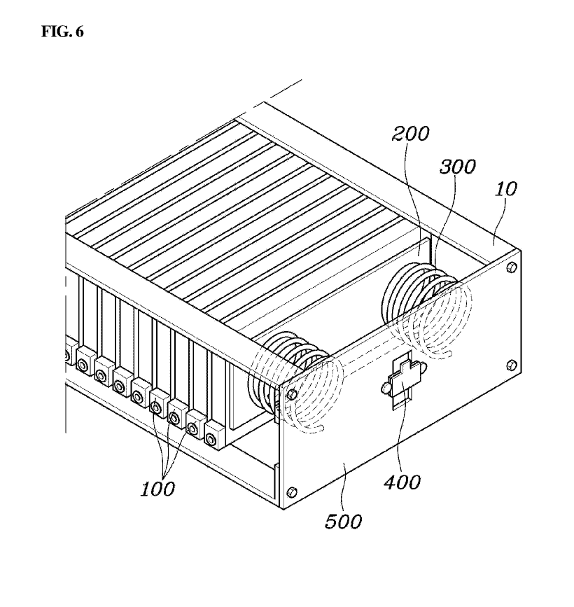

FIG. 6 is a perspective view illustrating an energy storage system for a vehicle according to another exemplary embodiment of the present disclosure. As illustrated in FIG. 6, an energy storage system for a vehicle according to another exemplary embodiment of the present disclosure may further include a second plate 500 positioned at a distance spaced apart from the first plate 200 by a predetermined interval, and coupled and fixed to the energy storage cell mounting part 10. In particular, the elastic member 300 may be positioned between the first plate 200 and the second plate 500, may have a first side coupled to the other surface of the first plate 200 and a second side coupled to a first surface of the second plate 500, and may be configured to provide the repulsive force of a certain magnitude or greater in the direction of the stacked energy storage cells through the first plate 200.

Further, when the energy storage cells 100 are charged at a preset value or less, the switching part 400 may be coupled to a position which is not in contact with the first plate 200, when the elastic member 300 is compressed as the energy storage cells 100 are expanded. According to an exemplary embodiment, when the protrusion 210 is formed on the second surface of the first plate 200, when the energy storage cells 100 are charged at a preset value or less, the switching part 400 may be coupled to a position which is not in contact with the protrusion 210 of the first plate 200, when the elastic member 300 is compressed as the energy storage cells 100 are expanded.

Further, when the energy storage cells 100 are charged above the preset value, the switching part 400 may be coupled to a position which is in contact with the first plate 200, when the elastic member 300 is compressed as the energy storage cells 100 are expanded. According to an exemplary embodiment, when the protrusion 210 is formed on the second surface of the first plate 200, when the energy storage cells 100 are charged above the preset value, the switching part 400 may be coupled to a position which is in contact with the protrusion 210 of the first plate 200, when the elastic member 300 is compressed as the energy storage cells 100 are expanded. In particular, when the first plate 200 or the protrusion 210 is in contact with the switching part 400, the switching part 400 may be configured to shut off the power supplied to the plurality of energy storage cells 100. When the first plate 200 or the protrusion 210 is in contact with the switching part 400, the switching part 400 may be configured to shut off the power supplied to the plurality of energy storage cells 100.

According to the present disclosure, the durability of the energy storage cells may be improved by providing repulsive force of a certain magnitude or greater in a direction of a plurality of energy storage cells stacked through a first plate by an elastic member to provide surface pressure of a certain magnitude or greater to the plurality of energy storage cells which are stacked to be in surface-contact with each other. The stability may be improved stability by shutting off power supplied to the energy storage cells when the energy storage cells are overcharged.

Although the present disclosure has been shown and described with respect to specific exemplary embodiments, it will be apparent to those having ordinary skill in the art that the present disclosure may be variously modified and altered without departing from the spirit and scope of the present disclosure as defined by the following claims

What is claimed is:

1. An energy storage system for a vehicle, comprising:
a plurality of energy storage cells mounted within an energy storage cell mounting part and stacked to be in surface-contact with each other;
a first plate having a first surface coupled to be in surface-contact with an exposed surface of an energy storage cell positioned at an outermost side among the plurality of energy storage cells; and
an elastic member having a first side coupled to a second surface of the first plate and a second side fixedly coupled to the energy storage cell mounting part, and configured to provide repulsive force of a certain magnitude or greater in a direction of the stacked energy storage cells through the first plate.

2. The energy storage system for a vehicle of claim 1, further comprising:
a switching part coupled to the energy storage cell mounting part and configured to shut off power supplied to the plurality of energy storage cells.

3. The energy storage system for a vehicle of claim 2, wherein when the energy storage cells are charged at a preset value or less, the switching part is coupled to a position which is not in contact with the first plate, when the elastic member is compressed as the energy storage cells are expanded.

4. The energy storage system for a vehicle of claim 2, wherein when the energy storage cells are charged above a preset value, the switching part is coupled to a position which is in contact with the first plate, when the elastic member is compressed as the energy storage cells are expanded.

5. The energy storage system for a vehicle of claim 4, wherein when the first plate is in contact with the switching part, the power supplied to the plurality of energy storage cells is shut off.

6. The energy storage system for a vehicle of claim 3, wherein a protrusion is formed on the second surface of the first plate.

7. The energy storage system for a vehicle of claim 4, wherein a protrusion is formed on the second surface of the first plate.

8. The energy storage system for a vehicle of claim 6, wherein when the energy storage cells are charged at the preset value or less, the switching part is coupled to a position which is not in contact with the protrusion of the first plate, when the elastic member is compressed as the energy storage cells are expanded.

9. The energy storage system for a vehicle of claim 6, wherein when the energy storage cells are charged above the preset value, the switching part is coupled to a position which is in contact with the protrusion of the first plate, when the elastic member is compressed as the energy storage cells are expanded.

10. The energy storage system for a vehicle of claim 8, wherein when the protrusion of the first plate is in contact with the switching part, the power supplied to the plurality of energy storage cells is shut off.

11. The energy storage system for a vehicle of claim 2, further comprising:
a second plate positioned at a distance spaced apart from the first plate by a predetermined interval, and coupled to be fixed to the energy storage cell mounting part.

12. The energy storage system for a vehicle of claim 11, wherein the elastic member is positioned between the first plate and the second plate, has the first side coupled to the second surface of the first plate and the second side coupled to a first surface of the second plate, and is configured to provide the repulsive force of the certain magnitude or greater in the direction of the stacked energy storage cells through the first plate.

13. The energy storage system for a vehicle of claim 11, wherein the switching part is coupled to the second plate.

14. The energy storage system for a vehicle of claim 13, wherein when the energy storage cells are charged at a preset value or less, the switching part is coupled to a position which is not in contact with the first plate, when the elastic member is compressed as the energy storage cells are expanded.

15. The energy storage system for a vehicle of claim 13, wherein when the energy storage cells are charged above a preset value, the switching part is coupled to a position which is in contact with the first plate, when the elastic member is compressed as the energy storage cells are expanded.

16. The energy storage system for a vehicle of claim 15, wherein when the first plate is in contact with the switching part, the power supplied to the plurality of energy storage cells is shut off.

17. The energy storage system for a vehicle of claim 1, wherein the elastic member is a plate spring or a coil spring.
